(19) United States
(12) Patent Application Publication
(10) Pub. No.: US 2008/0197697 A1
(43) Pub. Date: Aug. 21, 2008

(54) Hydraulic brake pressure control apparatus for vehicle

(76) Inventors: Takahiro Naganuma, Kariya-city (JP); Koji Yanai, Kariya-city (JP)

Correspondence Address: BUCHANAN, INGERSOLL & ROONEY PC, POST OFFICE BOX 1404, ALEXANDRIA, VA, 22313-1404, US

(21) Appl. No.: 12/071,173

(22) Filed: Feb. 15, 2008

(30) Foreign Application Priority Data
Feb. 21, 2007 (JP) 2007-040888
Nov. 8, 2007 (JP) 2007-290723

(51) Int. Cl. B60T 8/50; B60T 8/34

(52) U.S. Cl. 303/119.2

(57) ABSTRACT

A hydraulic brake pressure control apparatus has a hydraulic unit having a housing, a casing fixed to the housing, and a circuit board arranged in the casing. A resilient member is disposed between the housing and the casing such that the housing and the casing are separated from each other, in order to reduce vibration transfer from the hydraulic unit to the circuit board. A part of the resilient member is also disposed between a bolt inserted into a through-hole formed in the resilient member and the casing.

### CROSS REFERENCE TO RELATED APPLICATION

This application is based on Japanese Patent Application Nos. 2007-40888 filed on Feb. 21, 2007, and 2007-290723 filed on Nov. 8, 2007, the disclosures of which are incorporated herein by reference.

### FIELD OF THE INVENTION

The present invention relates to a hydraulic brake pressure control apparatus, which is incorporated into a vehicle hydraulic braking system having an electronic control function.

### BACKGROUND OF THE INVENTION

A hydraulic brake pressure control apparatus is incorporated into a vehicle hydraulic braking system having an electronic control function, wherein the hydraulic brake pressure control apparatus is composed of a hydraulic unit having a pump, an electric motor for driving the pump, and electromagnetic valves for controlling fluid pressure, and an electronic control unit. The electronic control unit is so composed that an electric circuit board having control circuits is arranged in a casing. The hydraulic brake pressure control apparatus of this kind is disclosed in patent publications, for example, Patent (PCT) Publication No. 2004-506572, and Japanese Patent Publication No. H11-43031.

In the hydraulic brake pressure control apparatus disclosed in the above Patent (PCT) Publication No. 2004-506572, an electronic controller (an electronic control unit) is held by a holder firmly fixed to a vehicle body, and a valve block (a hydraulic unit) is resiliently supported by the holder being separated from the electronic controller.

In the hydraulic brake pressure control apparatus disclosed in the above Japanese Patent Publication No. H11-43031, a coil supporting plate is fixed to an open side of a cover (casing) for electromagnetic valves, wherein the cover (casing) covers one end of a hydraulic unit. Coils for the electromagnetic valves are resiliently arranged and held between the cover and the coil supporting plate.

In the recent hydraulic brake pressure control apparatus, more and more components having sophisticated functions are incorporated. Functional components sensitive against vibrations, for example, semiconductor devices for control, sensors for detecting vehicle behaviors and fluid pressures, and so on, are mounted on a circuit board of the electronic control unit. Electrical connecting portions to be connected to terminals formed on the circuit board are also sensitive against the vibrations.

An electric motor for driving a pump, electromagnetic valves for fluid pressure control, and so on, which generate impacts and vibrations, are incorporated into a housing of a hydraulic unit. In case of a piston-type pump, the piston-type pump itself becomes one of sources for generating the vibrations. And the vibrations thus generated are likely to be transferred to the circuit board of the electronic control unit.

A structure, disclosed in the above Patent (PCT) Publication No. 2004-506572, has an object to decrease vibrations to be transferred from the hydraulic unit to the electronic control unit, wherein impacts and/or vibrations are attenuated by a buffering element of a resiliently supporting portion. Accordingly, affection by the vibration to the functional components and connecting portions of electric circuits can be suppressed to a smaller amount. However, a reliability of a connecting portion between the electronic controller and the valve block (e.g. a reliability of a seal at the open end of the cover, a reliability of electrical connection between the electronic controller and the valve block, and so on) may become insufficient, because the electronic controller is separated from the valve block.

On the other hand, in the apparatus disclosed in the above Japanese Patent Publication No. H11-43031, a sealing member is interposed between an open-side periphery of the cover for the electromagnetic valves and a sealing surface of the valve block, and the cover for the electromagnetic valves is fixed to the valve block of the hydraulic unit by means of bolts. Accordingly, a reliability of the connecting portion between the electronic control unit and the hydraulic unit is assured. In addition, vibration to be generated by the coils becomes smaller, because the coils for the electromagnetic valves are held between the coil supporting plate fixed to the open side of the cover for electromagnetic valves and a resilient member supported by the cover, so that movement of the coils is restricted. However, according to this conventional apparatus, the coil supporting plate is necessary in addition to the sealing member, which may increase manufacturing cost.

Furthermore, the resilient member is interposed between the coils of the electromagnetic valves and the cover for the electromagnetic valves, and the coils are held between the resilient member and the coil supporting plate. Accordingly, the vibration is transferred from the valve block to the circuit board via the cover for the electromagnetic valves.

### SUMMARY OF THE INVENTION

The present invention is made in view of the foregoing problems, and has an object to provide a hydraulic brake pressure control apparatus, wherein vibration transfer from the hydraulic unit to the electronic control unit can be effectively suppressed in order to protect functional components mounted on a circuit board and electrical connecting portions formed on the circuit board.

According to a feature of the present invention, a hydraulic brake pressure control apparatus for a vehicle has a hydraulic unit, which has a housing, and an electric motor and electromagnetic valves incorporated into the housing. The apparatus further has a casing, which has fixing portions and is fixed to one end of the housing by bolts, wherein the bolts are inserted into through-holes formed at the fixing portions. The apparatus further has a circuit board, which has a control circuit and is arranged in the casing. A resilient member is disposed between the housing and the casing, such that the housing and the casing are entirely separated from each other, and a part of the resilient member is also disposed between the bolts and the casing.

The hydraulic brake pressure control apparatus according to the present invention may have one or combination of the following features, as the case may be:
(1) The resilient member has a sealing portion for fluid tightly sealing a gap between the housing and the casing at their respective sealing surfaces.
(2) The resilient member has a coil supporting portion for supporting a coil of the electromagnetic valve, so that the coil is arranged and supported in an inside space of the casing.
(3) The coil supporting portion is formed as a recess formed on the resilient member, and the coil is supported by a bottom surface and an inner peripheral surface of the recess.
(4) The resilient member has a vibration transfer suppressing portion for suppressing vibration transfer between the fixing portion and the housing.
(5) The resilient member has a sealing portion for fluid tightly sealing a gap between the housing and the casing at their respective sealing surfaces, a coil supporting portion for supporting a coil of the electromagnetic valve, so that the coil is arranged and supported in an inside space of the casing, and a vibration transfer suppressing portion for suppressing vibration transfer between the fixing portion and the housing, wherein the sealing portion, the coil supporting portion and the vibration transfer suppressing portion are integrally formed.
(6) The vibration transfer suppressing portion has a first resilient portion, which is disposed between the fixing portion and the housing at their respective sealing surfaces.
(7) The part of the resilient member, which is disposed between the bolts and the casing, has a first interposed portion arranged between an inner peripheral surface of the through-hole and an outer peripheral surface of the bolt.
(8) The bolt has a screw portion and a head portion provided at one end of the screw portion and having a larger diameter than that of the screw portion.
The part of the resilient member, which is disposed between the bolts and the casing, has a second interposed portion arranged between a bearing surface of the head portion and a surface of the fixing portion opposing to the bearing surface.
(9) The vibration transfer suppressing portion has a first resilient portion, which is disposed between the fixing portion and the housing at their respective sealing surfaces; and a second resilient portion, which is disposed between the bolt inserted into the through-hole and the fixing portion.
The second resilient portion, which is disposed between the bolt and the fixing portion, has a first interposed portion arranged between an inner peripheral surface of the through-hole and an outer peripheral surface of the bolt; and a second interposed portion arranged between a bearing surface of the head portion and a surface of the fixing portion opposing to the bearing surface.
The first and second resilient portions are integrally formed.
(10) The first interposed portion formed into a cylindrical shape projects from a first resilient portion, which is disposed between the fixing portion and the housing at their respective sealing surfaces in a direction opposite to the housing.
A projecting forward end of the first interposed portion is divided into multiple portions in a circumferential direction to form the second interposed portion.
The second interposed portion is bent so that the second interposed portion is arranged between the bearing surface of the head portion and the surface of the fixing portion opposing to the bearing surface.
(11) An inner-diameter enlarging portion is formed at an inner surface of the second resilient portion, such that an inner diameter of the second resilient portion increases toward a forward end of the second resilient portion.
(12) A notched groove is formed at an outer peripheral surface of the second resilient portion.
(13) A thin-walled portion is formed at an outer peripheral surface of the second resilient portion.
(14) A collar is inserted into the through-hole. A washer is arranged between the bearing surface of the head portion and the surface of the fixing portion opposing to the bearing surface. The first interposed portion is arranged at an outer peripheral surface of the collar. The second interposed portion is arranged between the washer and the surface of the fixing portion opposing to the washer.

The above mentioned washer may be integrally formed with the collar, or may be separately formed from the collar.

According to the hydraulic brake pressure control apparatus of the present invention, the resilient member is disposed between the housing of the hydraulic unit and the casing for the electromagnetic valves, such that the housing and the casing are entirely separated from each other. Furthermore, a part of the resilient member is disposed between the bolt and the casing, such that the bolt and the casing are entirely separated from each other. As a result, vibration transfer from the housing to the casing is carried out via the resilient member, which has a function of absorbing vibration, so that vibration to be transferred is attenuated by the resilient member. The vibration is, therefore, hardly transferred to the casing.

Furthermore, a sealing portion for fluid tightly sealing a gap between the housing and the casing at their respective sealing surfaces as well as a coil supporting portion for supporting a coil of the electromagnetic valve is formed in the resilient member. Accordingly, a special sealing member and a special coil supporting member are no longer necessary, to thereby reduce a number of parts and manufacturing cost.

### BRIEF DESCRIPTION OF THE DRAWINGS

The above and other objects, features and advantages of the present invention will become more apparent from the following detailed description made with reference to the accompanying drawings. In the drawings:

FIG. 1 is a side view showing a brake fluid pressure control apparatus according to an embodiment of the present invention;

FIG. 2 is a side view, partly including a cross sectional view, showing the brake fluid pressure control apparatus of FIG. 1;

FIG. 3 is a top plan view of a resilient member used in the apparatus of FIG. 1;

FIG. 4 is a side view of the resilient member of FIG. 3;

FIG. 5 is an enlarged cross sectional view taken along a line V-V in FIG. 3;

FIG. 6 is an enlarged perspective view showing a vibration transfer suppressing portion of the resilient member shown in FIG. 3;

FIG. 7A is an enlarged cross sectional view showing a fixing portion of a casing fixed to a housing;

FIG. 7B is a top plan view showing the fixing portion of the casing;

FIGS. 8A to 8D are cross sectional views showing modifications of vibration transfer suppressing portion formed in a resilient member;

FIGS. 9A and 9B are cross sectional views showing further modifications of vibration transfer suppressing portion formed in a resilient member;

FIGS. 10A and 10B are an enlarged cross sectional view and a top plan view showing a modification of a vibration transfer suppressing portion formed in a resilient member; and

FIGS. 11A and 11B are an enlarged cross sectional view and a top plan view showing a further modification of a vibration transfer suppressing portion formed in a resilient member.

### DETAILED DESCRIPTION OF THE PREFERRED EMBODIMENTS

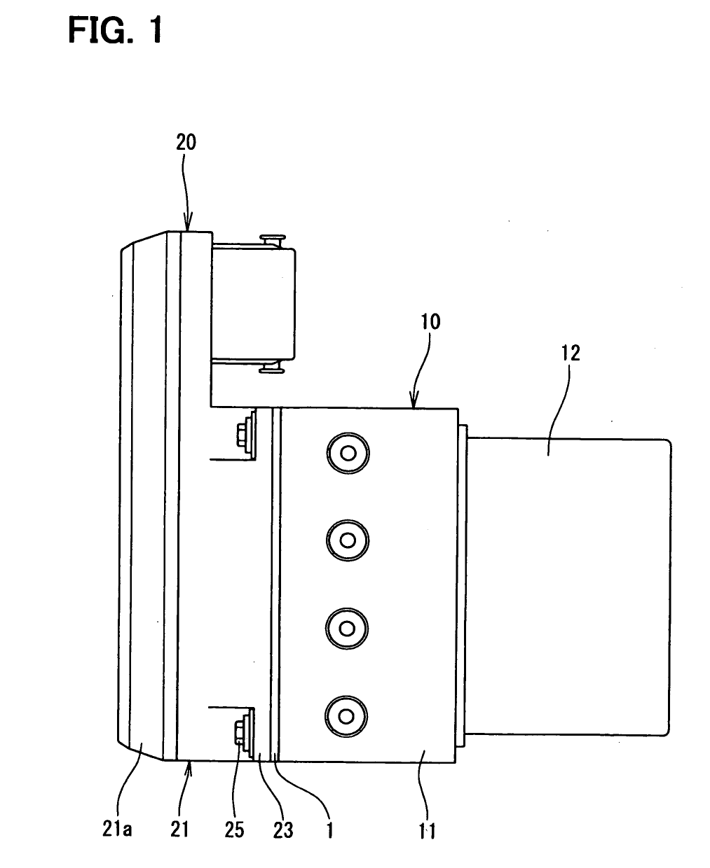

An embodiment of the present invention will be explained with reference to the attached drawings. FIG. 1 is a schematic view showing an entire control apparatus for brake fluid pressure. The brake fluid pressure control apparatus is composed of a hydraulic unit 10 and an electronic control unit 20 (hereinafter referred to as ECU 20).

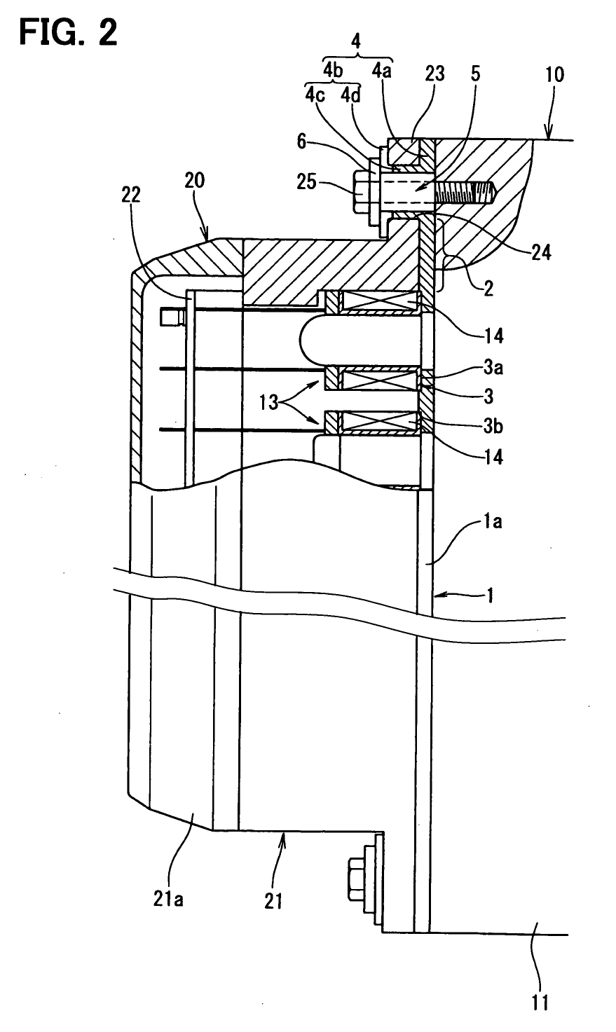

The hydraulic unit 10 incorporates a pump (not shown) into a housing 11, which is made of a metal such as aluminum alloy. An electric motor 12 for operating the pump is attached to a side portion of the housing 11. Fluid passages, which are connected to a suction port and an outlet port of the pump, as well as a discharge port to a reservoir, are formed in the inside of the housing 11. In addition, an electromagnetic valve for controlling fluid pressure of a wheel cylinder (not shown), and multiple electromagnetic valves for opening and closing fluid passages are incorporated into the housing 11. Furthermore, a pressure sensor and a damper may be incorporated into the housing 11, as the case may be. A coil 14 of an electromagnetic valve 13, which is incorporated into the housing 11, is shown in FIG. 2.

The ECU 20 has a resin casing 21 covering one end of the housing 11 (FIG. 2) and a printed circuit board 22 accommodated in the resin casing 21 surrounded by a cover 21a. The resin casing 21 has a plurality of fixing portions 23 at a periphery thereof, so that the casing 21 is fixed to the housing 11 by bolts 25 inserted into through-holes 24 at the fixing portions 23.

The printed circuit board 22 has a control circuit (not shown), functional components (electronic parts, such as ECU, sensors, and so on) forming the control circuit, and connecting portions for electrical circuits. It is preferable to apply less mechanical vibrations to those parts (portions) and components.

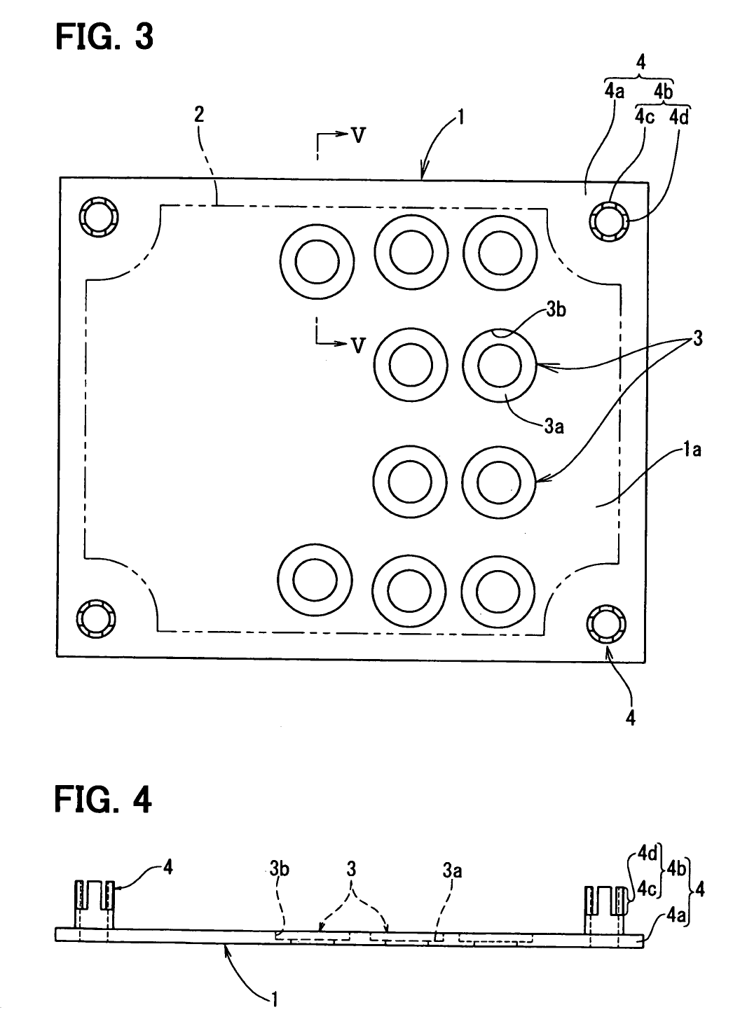

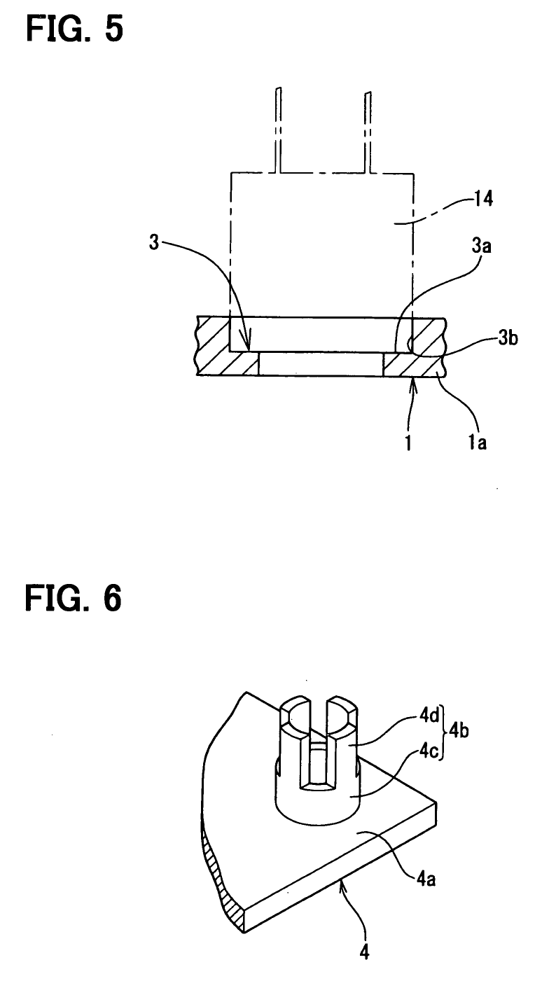

A resilient member 1, such as rubber, is provided between the resin casing 21 and the housing 1. A detailed structure of the resilient member 1 is shown in FIGS. 3 to 6. The resilient member 1 has a sealing portion 2 interposed between an open end of the resin casing 21 and one end of the housing 11 as shown in FIG. 2 in order to seal a contacting portion between the resin casing 21 and the housing 11. The resilient member 1 also has multiple coil supporting portions 3 for supporting the coils 14 of the electromagnetic valves 13 in the inside of the resin casing 21. Furthermore, the resilient member 1 has vibration transfer suppressing portions 4 to be disposed at the fixing portions 23 in channels for vibration transfer between the housing 11 and the resin casing 21. The above mentioned portions (2, 3, and 4) are integrally formed with a flat base plate 1a. In the drawings of FIGS. 1, 2 and 4, a thickness of the resilient member 1 is exaggerated. The resilient member 1 is interposed between the housing 11 and the resin casing 21, such that the housing 11 and the resin casing 21 are separated from each other. As a result, vibration transmitted from the housing 11 is absorbed and attenuated by the resilient member 1. Therefore, the vibration is hardly transmitted to the resin casing 21.

An outer portion of the resilient member 1, which is surrounded by an outer periphery and a two-dot-chain line in FIG. 3, is used as the sealing portion 2. And recesses formed in the base plate 1a are used as the coil supporting portions 3. The vibration transfer suppressing portion 4 is composed of a first resilient portion 4a of a sheet shape interposed between the fixing portion 23 and the housing 11, and a second resilient portion 4b projecting in one direction from the first resilient portion 4a. The second resilient portion 4b has a cylindrical portion (a first interposed portion) 4c which is arranged between an inner surface of the through-hole 24 and an outer surface of the bolt 25, and flanged portions (second interposed portions) 4d which are formed at a projecting end of the cylindrical portion (the first interposed portion) 4c and divided into multiple portions in a circumferential direction. In the embodiment, the first and second resilient portions 4a and 4b are integrally formed with each other, but they may be formed by separate members.

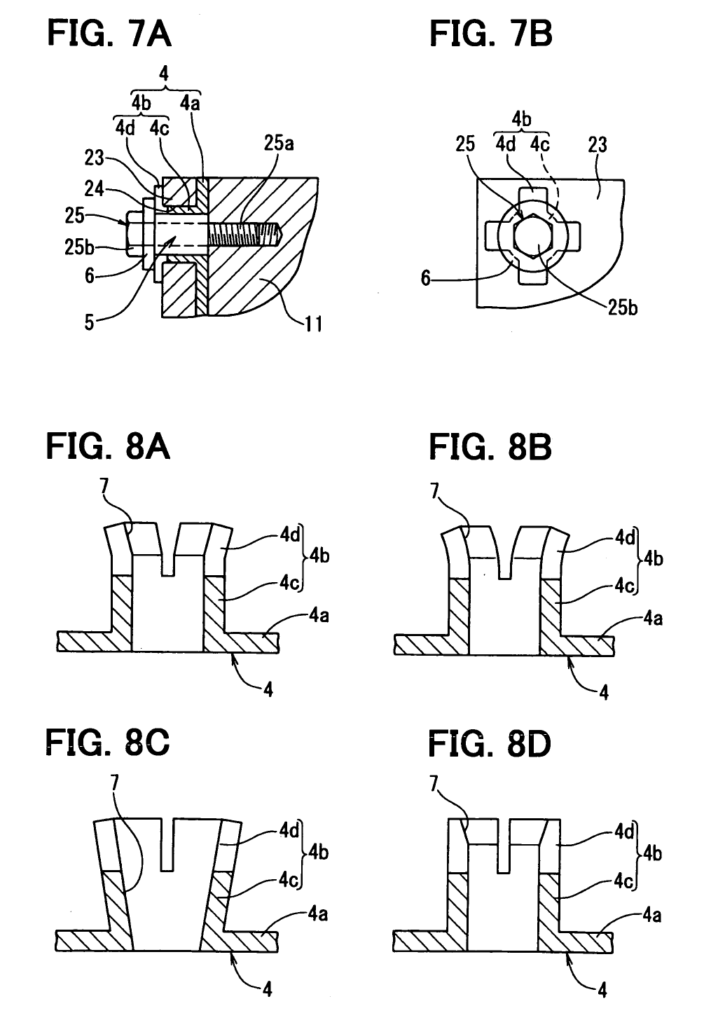

As shown in FIG. 7A, a metal collar 5 is inserted into the through-hole 24 formed at the fixing portion 23, the bolt 25 is then inserted through the metal collar 5, and the bolt 25 is screwed into a screw portion formed in the housing 11, so that the resin casing 21 is fixed to the housing 11. Although the metal collar 5 is not always necessary, it is possible with the metal collar 5 to prevent a generation of a creep at the fixing portion 23 and it is easier to achieve a large fixing force by the bolt 25.

The bolt 25 has a screw portion 25a and a head portion 25b provided at one end of the screw portion 25a and having a larger diameter than that of the screw portion 25a. A washer 6 is disposed between a bearing surface of the head portion 25b and a surface of the fixing portion 23 facing to the bearing surface. In the drawing (FIG. 7A), the washer 6 is formed as a flange at one end of the metal collar 5 and integrally formed with the metal collar 5. The washer may be made of a separate member, which can be used together with a collar having no flange.

The resilient member 1 is attached to one side of the housing 11, such that the coil supporting portions 3 of the resilient member 1 are arranged between the coils 14 and the housing 11 in order to assemble the coils 14. The coils 14 are inserted into the recesses formed at the coil supporting portions 3, so that the coil 14 is supported by a bottom surface 3a and an inner peripheral surface 3b of the recess. As a result, movements of the coils 14 in axial and radial directions are restricted.

The resin casing 21 is then fixed to the housing 11, wherein each of the second resilient portions 4b, which projects from the flat base plate 1a, is inserted into the respective through-hole 24 formed in the resin casing 21. Next, the metal collar 5 is inserted into the first interposed portion 4c of the second resilient portion 4b from a side opposite to the housing 11. And the bolt 25 is inserted into the metal collar 5 and screwed into the housing 11.

The second interposed portions 4d, which are formed at the projecting end of the first interposed portion 4c (the second resilient portion 4b) and divided into multiple portions in the circumferential direction, are pushed by the washer 6 (the flange of the metal collar 5), so that the second interposed portions 4d are bent in a radial pattern as shown in FIG. 7B and interposed between the washer 6 and the fixing portion 23 of the resin casing 21 as shown in FIG. 7A.

According to such a structure, the resin casing 21 is separated from the housing 11 even at the fixing portions 23, and also separated from the bolt 25 by means of the resilient member 1. As a result, the vibration transfer from the housing 11 to the resin casing 21 is carried out through the resilient member 1, so that the vibration to be transferred is attenuated due to vibration absorbing performance of the resilient member 1.

In the electronic control unit (ECU) 20 shown in the drawings, the printed circuit board 22 is assembled and the cover 21a is attached to complete the assembling of the apparatus.

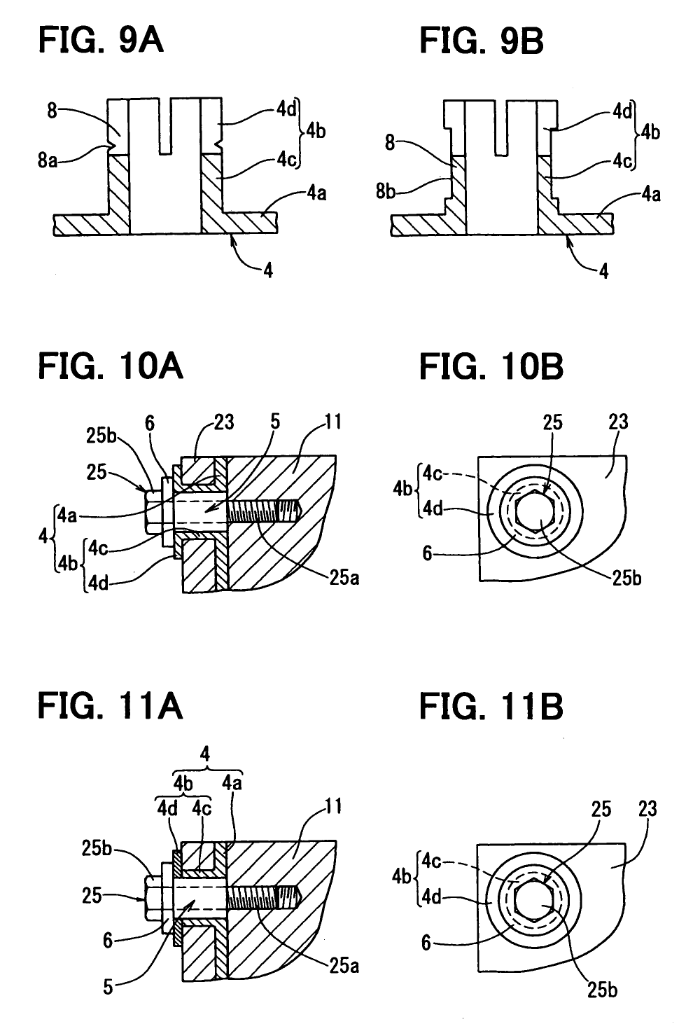

It is more preferable to have a shape for the vibration transfer suppressing portion 4 of the resilient member 1, as shown in FIGS. 8A to 8D and FIGS. 9A and 9B. In each of modifications shown in those drawings, the vibration transfer suppressing portion 4 has such a shape that second interposed portions 4d are naturally bent in radial and outward directions, when the second resilient portion 4b is pressed by the washer 6 as the bolt 25 is screwed into the housing 11.

More exactly, an inner-diameter enlarging portion 7 is formed at the second resilient portion 4b, such that an inner diameter of the second resilient portion 4b becomes larger toward a top forward end of the second resilient portion 4b. For example, in FIG. 8A or 8B, a forward end portion of the second interposed portion 4d is slightly bent in the radial and outward direction. The inner-diameter enlarging portion 7 of FIG. 8A has a flat inner surface, whereas the inner-diameter enlarging portion 7 of FIG. 8B has a curved inner surface. In the modification of FIG. 8C, not only the second interposed portion 4d but also the first interposed portion 4c has an inclined inner surface as the inner-diameter enlarging portion 7. In FIG. 8D, an inclined inner surface is formed at the top end of the second resilient portion 4b (a thickness of the second interposed portion 4d is gradually decreased toward the forward end).

Furthermore, as shown in FIG. 9A, a notched groove 8a may be formed at an outer peripheral surface of the second interposed portion 4d. Multiple grooves may be formed. In the modification of FIG. 9B, a thin-walled portion 8b is formed at an outer peripheral surface of the first interposed portion 4c and/or the second interposed portion 4d.

As shown in FIGS. 10A and 10B, the second interposed portion 4d maybe formed as an integral part of the second resilient portion 4b, wherein the second interposed portion 4d is formed into a disc shape before the bolt 5 is screwed into the housing 11.

Alternatively, the second interposed portion 4d may be formed as a separate member from the first interposed portion 4c of the second resilient portion 4b, as shown in FIGS. 11A and 11B, wherein the second interposed portion 4d may be made of rubber and formed into a disc shape like a washer made of rubber.

As explained above, the sealing portion 2, the coil supporting portions 3 and the vibration transfer suppressing portions 4 are integrally formed in the resilient member 1, so that labor hours for manufacturing and assembling processes as well as manufacturing cost can be reduced.

What is claimed is:

1. A hydraulic brake pressure control apparatus for a vehicle comprising:
a hydraulic unit having;
a housing;
an electric motor and electromagnetic valves, which are incorporated into the housing;
a casing having fixing portions and fixed to one end of the housing by bolts, which are inserted into through-holes formed at the fixing portions;
a circuit board having a control circuit and arranged within and held by the casing; and
a resilient member disposed between the housing and the casing, such that the housing and the casing are entirely separated from each other, apart of the resilient member being also disposed between the bolts and the casing.

2. A hydraulic brake pressure control apparatus according to claim 1, wherein
the resilient member has a sealing portion for fluid tightly sealing a gap between the housing and the casing at their respective sealing surfaces.

3. A hydraulic brake pressure control apparatus according to claim 1, wherein
the resilient member has a coil supporting portion for supporting a coil of the electromagnetic valve, so that the coil is arranged and supported in an inside space of the casing.

4. A hydraulic brake pressure control apparatus according to claim 3, wherein
the coil supporting portion is formed as a recess formed on the resilient member, and the coil is supported by a bottom surface and an inner peripheral surface of the recess.

5. A hydraulic brake pressure control apparatus according to claim 1, wherein
the resilient member has a vibration transfer suppressing portion for suppressing vibration transfer between the fixing portion and the housing.

6. A hydraulic brake pressure control apparatus according to claim 1, wherein the resilient member has;
a sealing portion for fluid tightly sealing a gap between the housing and the casing at their respective sealing surfaces;
a coil supporting portion for supporting a coil of the electromagnetic valve, so that the coil is arranged and supported in an inside space of the casing; and
a vibration transfer suppressing portion for suppressing vibration transfer between the fixing portion and the housing,
wherein the sealing portion, the coil supporting portion and the vibration transfer suppressing portion are integrally formed.

7. A hydraulic brake pressure control apparatus according to claim 5, wherein
the vibration transfer suppressing portion has a first resilient portion, which is disposed between the fixing portion and the housing at their respective sealing surfaces.

8. A hydraulic brake pressure control apparatus according to claim 1, wherein
the part of the resilient member, which is disposed between the bolts and the casing, has a first interposed portion arranged between an inner peripheral surface of the through-hole and an outer peripheral surface of the bolt.

9. A hydraulic brake pressure control apparatus according to claim 1, wherein
the bolt has
a screw portion; and
a head portion provided at one end of the screw portion
and having a larger diameter than that of the screw portion, and
the part of the resilient member, which is disposed between the bolts and the casing, has a second interposed portion arranged between a bearing surface of the head portion and a surface of the fixing portion opposing to the bearing surface.

10. A hydraulic brake pressure control apparatus according to claim 5, wherein
the vibration transfer suppressing portion has;
a first resilient portion, which is disposed between the fixing portion and the housing at their respective sealing surfaces; and
a second resilient portion, which is disposed between the bolt inserted into the through-hole and the fixing portion,
the second resilient portion, which is disposed between the bolt and the fixing portion, has;
a first interposed portion arranged between an inner peripheral surface of the through-hole and an outer peripheral surface of the bolt; and
a second interposed portion arranged between a bearing surface of the head portion and a surface of the fixing portion opposing to the bearing surface, and
the first and second resilient portions are integrally formed.

11. A hydraulic brake pressure control apparatus according to claim 10, wherein
the first interposed portion is formed into a cylindrical shape and projects from the first resilient portion, which is disposed between the fixing portion and the housing at their respective sealing surfaces in a direction opposite to the housing,
a projecting forward end of the first interposed portion is divided into multiple portions in a circumferential direction to form the second interposed portion, and
the second interposed portion is bent so that the second interposed portion is arranged between the bearing surface of the head portion and the surface of the fixing portion opposing to the bearing surface.

12. A hydraulic brake pressure control apparatus according to claim 11, wherein
an inner-diameter enlarging portion is formed at an inner surface of the second resilient portion, such that an inner diameter of the second resilient portion increases toward a forward end of the second resilient portion.

13. A hydraulic brake pressure control apparatus according to claim 11, wherein
a notched groove is formed at an outer peripheral surface of the second resilient portion.

14. A hydraulic brake pressure control apparatus according to claim 11, wherein
a thin-walled portion is formed at an outer peripheral surface of the second resilient portion.

15. A hydraulic brake pressure control apparatus according to claim 11, wherein
a collar is inserted into the through-hole,
a washer is arranged between the bearing surface of the head portion and the surface of the fixing portion opposing to the bearing surface,
the first interposed portion is arranged at an outer peripheral surface of the collar, and
the second interposed portion is arranged between the washer and the surface of the fixing portion opposing to the washer.
